(19) United States
(12) Patent Application Publication
(10) Pub. No.: US 2018/0285565 A1
(43) Pub. Date: Oct. 4, 2018

(54) MALWARE DETECTION IN APPLICATIONS BASED ON PRESENCE OF COMPUTER GENERATED STRINGS

(71) Applicant: Avast Software s.r.o., Praha 4 (CZ)

(72) Inventor: Denis Konopiský, Sedlec-Prcice (CZ)

(21) Appl. No.: 15/942,129

(22) Filed: Mar. 30, 2018

Related U.S. Application Data
(60) Provisional application No. 62/479,153, filed on Mar. 30, 2017.

(51) Int. Cl. G06F 21/56; G06F 17/30

(52) U.S. Cl. CPC G06F 21/565; G06F 2221/033; G06F 17/30985

(57) ABSTRACT

An executable file can be determined to be malicious based, at least in part, on the presence of a computer generated text string as a function name, method name, or variable name. The attributes of the function names, method names, and variable names in an executable file can be determined. The attributes can include the ratio of consonants to vowels for at least one text string in the executable file. The attributes may also include the number of consonants in a sequence uninterrupted by a vowel for at least one text string in the executable file. If the attributes indicate that a function name, method name or variable name has been computer generated, the executable file can be labeled as potentially malicious.

### CROSS-REFERENCE TO RELATED APPLICATIONS

This Application claims priority to U.S. Provisional Patent Application Ser. No. 62/479,153, filed on Mar. 30, 2017, entitled “Malware Detection in Applications Based on Presence of Computer Generated Strings,” currently pending, the entire disclosure of which is incorporated herein by reference.

### FIELD OF INVENTION

The present invention relates generally to malware detection, and more particularly, to detecting malware based on the presence of computer generated strings.

### BACKGROUND OF INVENTION

Malware, short for “malicious software,” is software that can be used to disrupt computer operations, damage data, gather sensitive information, or gain access to private computer systems without the user's knowledge or consent. Examples of such malware include software viruses, trojan horses, rootkits, ransomware etc. A common mechanism used by malware developers is to embed the malware into a file that is made to appear desirable to user, or is downloaded and executed when the user visits a web site. For example, malware may be embedded into an executable file or software application that appears legitimate and useful. The user downloads the file, and when the file is opened, the malware within the file is executed. A file that contains malware can be referred to as a malicious file.

Detection of malware in order to protect computing devices is of major concern. Correctly identifying which files contain malware and which are benign can be a difficult task, because malware developers often obfuscate various attributes of the malware in an attempt to avoid detection by anti-malware software. For example, malware creators often try to hide malicious attributes by naming functions, methods and/or variable names with randomly computer generated names.

Accordingly, a need exists for a system and method that can detect malware based on the presence of a computer generated function name, a variable name, and/or a method name in an executable file or application. A need also exists for a system and method adapted for determining whether a text string in an executable file or application is a computer generated text string.

### SUMMARY OF INVENTION

The present invention generally relates to a system and method for detecting malware in a file. One embodiment of the present invention is directed to a method wherein an executable file is received and a set of text strings in the executable file is determined. The text strings may include at least of a function name, a variable name, or a method name. Various aspects of one or more of the text strings are analyzed to determine whether at least one of the text strings is a computer generated text string. An iteration loop can be employed in evaluating the text strings.

A determination can be made as to whether a ratio of consonants to vowels in at least one of the text strings is greater than a predetermined or configurable threshold value. In doing so, the number of consonants and the number of vowels in a text string is determined. The number of consonants may be divided by the number of vowels to determine the ratio of consonants to vowels in the text string. If the ratio of consonants to vowels in the text string is greater than a predetermined or configurable threshold value, the text string may be indicated as likely being a computer generated string. In one embodiment, the threshold value for the ratio of consonants to vowels is 3.0, for example.

A determination can also be made as to whether the number of consonants in a sequence uninterrupted by a vowel in the text string is greater than a predetermined or configurable threshold value. If the number of consonants in a sequence uninterrupted by a vowel in the text string is greater than a predetermined or configurable threshold value, the text string may be indicated as likely being a computer generated string. In one embodiment, the threshold value for the number of consonants in a sequence uninterrupted by a vowel is 3.0, for example.

Another embodiment of the present invention relates to a non-transitory machine-readable medium having instructions stored thereon, the instructions comprising computer executable instructions that when executed are configured for detecting malware in an file based on the presence of a computer generated text string. In one embodiment, the computer executable instructions cause one or more processors to undertake one or more steps of the method generally described above.

A further aspect of the present invention relates to a system that includes one or more processors and a non-transitory machine-readable medium having computer executable instructions stored thereon adapted for detecting malware in an file based on the presence of a computer generated text string as generally described above.

### BRIEF DESCRIPTION OF THE DRAWINGS

For a better understanding of the inventive subject matter, reference may be made to the accompanying drawings in which:

FIG. 1 is a flowchart illustrating operations of a method for detecting malware based on the presence of computer generated strings according to one embodiment of the present invention;

FIG. 2 is a flowchart illustrating operations of a method for determining that a string is a computer generated string according to one embodiment of the present invention;

FIG. 3 is a block diagram illustrating an example system for detecting malware based on the presence of computer generated strings according to one embodiment of the present invention; and

FIG. 4 is a block diagram of an example embodiment of a computer system upon which embodiments of the inventive subject matter can execute.

### DETAILED DESCRIPTION

In the following detailed description of example embodiments of the invention, reference is made to the accompanying drawings that form a part hereof, and in which is shown by way of illustration specific example embodiments in which the invention may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the figures, the same reference number is used throughout to refer to an identical component that appears in multiple figures. Signals and connections may be referred to by the same reference number or label, and the actual meaning will be clear from its use in the context of the description. In general, the first digit(s) of the reference number for a given item or part of the invention should correspond to the figure number in which the item or part is first identified.

The description of the various embodiments is to be construed as examples only and does not describe every possible instance of the inventive subject matter. Numerous alternatives could be implemented, using combinations of current or future technologies, which would still fall within the scope of the claims. The following detailed description is, therefore, not to be taken in a limiting sense, and the scope of the inventive subject matter is defined only by the appended claims.

When a developer is creating an Android application, he or she usually uses regular words as names for variables, functions, methods and values. For example, a function that will subtract two numbers could be called “subtractNumbers”. This is a human readable name that can be understood and it serves as a brief description of the function. By using regular words in any language, the source code can be made easier to understand.

However, an easy way to tell whether an application is malicious is to look at the names of the methods, functions and variables. For example if there is a function called “infectDevice” or “getPrivateData”, it can be easy to determine that such function names are indicators of malicious activity. Even the most basic antivirus software would probably flag this application as malicious just by looking at the names of functions. Thus, malware creators often try to hide this malicious activity by naming the methods with randomly generated names, for example, “infectDevice” could be substituted with “pqrtpqrpqrt”. It cannot be readily determined what the function does based on such a name, and similarly, a conventional antivirus program will not be able to tell either. Creators of genuine applications do not have the need to hide any activity typically do not use randomly generated names in their application. Thus, the presence of a computer generated function, method and/or variable name in an application can be an indicator of a potential malicious activity.

A word in any language has consonants and vowels. The sequence of characters creates a word. A word can have attributes defined by the occurrence of individual letters, their count and their order. For example the word “invention” has 5 consonants, 4 vowels and consists of 9 characters. In this case the ratio between consonants and vowels is 1.25 and the highest number of consonants in a row is 2. An example of a randomly generated word of the type often used in a malware application is “qwiqpwhqpifh.” This text string has 10 consonants and 2 vowels. The consonant to vowel ratio in this case is 5 and the highest number of consonants in a row is 6. When comparing the consonant to vowel ratio in the word “invention” and the consonant to vowel ratio in the randomly generated string “qwiqpwhqpifh”, it can be seen that there is a big difference in the consonant to vowel ratio and in the number of consonants in a row.

By looking at a list of 350,000 English words we can tell that the average consonant to vowel ratio is 1.5652 and in 97% of the words, the ratio is smaller or equal to three (3). From this information, it can be determined that if the consonant to vowel ratio in a text string is higher than three, there is a 97% probability that a computer randomly generated the characters in the text string. A majority of English words contain no more than three consonants in a row. This attribute can also use that as an additional indicator of computer generated text.

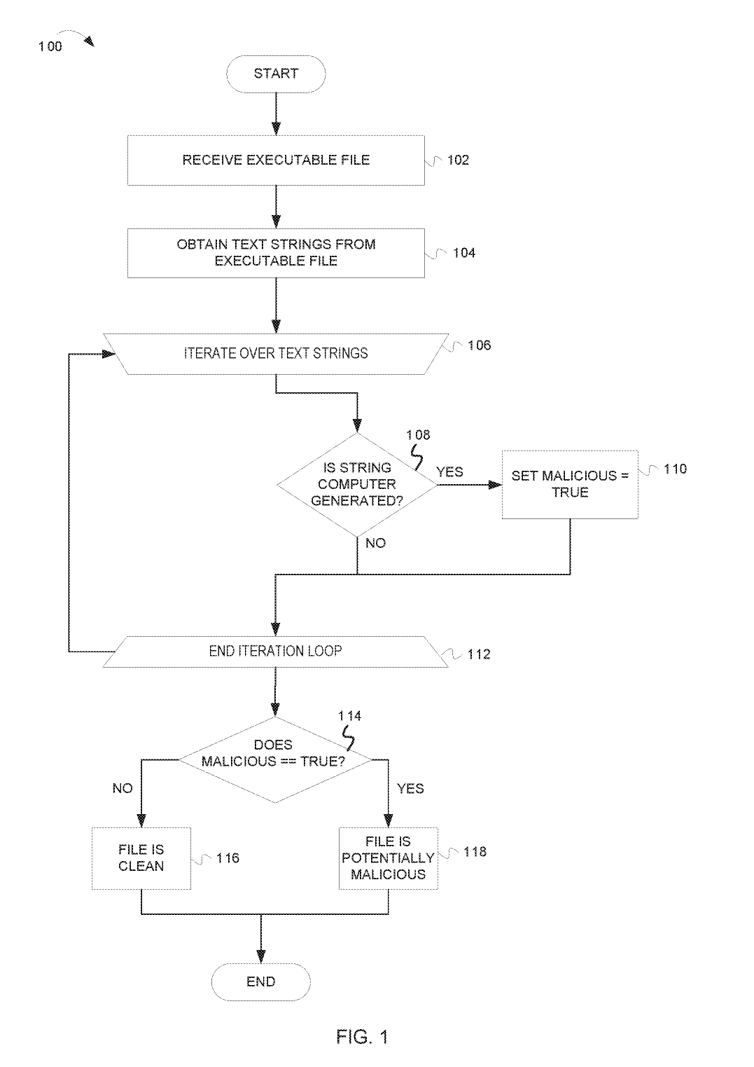

FIG. 1 is a flowchart 100 illustrating operations of a method for detecting malware based on the presence of computer generated strings. At block 102, the method receives an executable file as input. The executable file can be any type of file that contains executable instructions. For example, the executable file can be an application, an object code library, or an object code file. In embodiments where the executable file is for the Android operating system, an “.apk” file can be received. In alternative embodiments, the executable file can be a Portable Executable (PE) file that is commonly used on various versions of the Microsoft Windows family of operating systems. In further alternative embodiments, the executable file can be an ELF file commonly used in Linux or UNIX based systems or a Mach-0 file commonly used in MAC OS X operating systems.

At block 104, text strings for function names, method names, and/or variable names are obtained from the executable file. In embodiments where the executable file is for the Android operating system, the text string can be obtained from a “classes.dex” file that can be unpacked from a .apk file. The classes.dex file contains the instructions, functions and methods that are used in an application that runs on an Android operating system. The dex file has a given structure. One of the parts of the classes.dex file is a string pool with method names, variable names and string values used in the application's source code. Other operating systems can have portions of executable files that can provide similar information.

Block 106 is the top of a loop that iterates over the text strings obtained at block 104. The operations at block 108 and block 110 can be performed for each iteration of the loop, that is, for each text string obtained at block 104.

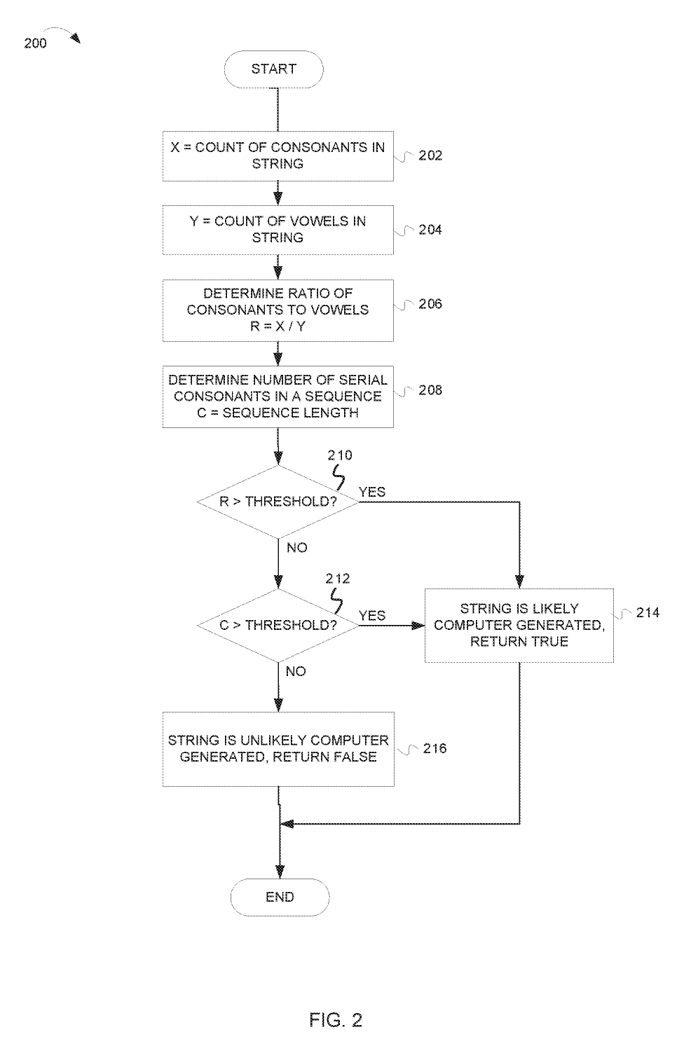

At block 108, a check is made to determine if the text string is likely to be a computer generated string. As an example, a computer generated string can be a string of randomly determined characters. Various attributes of the text string can be checked. Further details of a method for determining that a text string is computer generated are provided below with reference to FIG. 2. If it is determined that the text string is likely a computer generated text string, then flow proceeds to block 110. Otherwise, flow proceeds to block 112, which is the end of the iteration loop.

At block 110, an indicator (referred to as “MALICIOUS”) is set with a value that indicates that the file potentially contains malware. In some embodiments, flow can proceed to block 112, the end of the iteration loop. In alternative embodiments, upon determining the presence of a computer generated text string for a function name, method name, or variable name, the iteration over the text strings can be terminated early, and flow can proceed to block 114.

Block 112 is the bottom of the iteration loop. If further text strings remain to be processed, then flow can return to the top of the loop at block 106. If all text strings have been processed, flow proceeds to block 114.

At block 114, a check is made to determine if the MALICIOUS indicator was set to indicate that a computer generated string was found for a function name, method name, or variable name. If the MALICIOUS indicator is not set during the iteration over the text strings, then flow proceeds to block 116 where the method determines that the file is likely clean, i.e., free from malware. If the MALICIOUS indicator was set, then at block 118, the method determines that the file is potentially malicious, i.e., the file potentially contains malware.

In some embodiments, a single instance of a computer generated string for a function name, method name or variable name can result in a file being labeled as potentially malicious. In alternative embodiments, a threshold number or percentage of computer generated function names, method name and/or variable names may be needed before a file is labeled as potentially malicious.

FIG. 2 is a flowchart 200 illustrating operations of a method for determining that a string is a computer generated string. As mentioned above, aspects of the method demonstrated in FIG. 2 may be incorporated into block 108 shown in FIG. 1 in analyzing whether a text string is a computer generated text string.

At block 202, a count is made of the consonants in the text string. The count can be stored in a variable “X”.

At block 204, a count is made of the vowels in the text string. The count can be stored in a variable “Y”.

At block 206, a ratio of consonants to vowels is determined and stored in a variable “R”, where R=X/Y.

At block 208, the number of consonants in a sequence uninterrupted by a vowel is determined. The number can be stored in a variable “C.”

At block 210, a check is made to determine if the ratio R of consonants to vowels exceeds a threshold value. In some embodiments, a value of three (3) can be used as the threshold value; however, it will be appreciated that other threshold values are also within the scope of the present invention. If the ratio of consonants to vowels exceeds the threshold value, then flow proceeds to block 214, where the method indicates that the string is likely a computer generated string. If the ratio of consonants to vowels is below the threshold value, then flow proceeds to block 212.

At block 212, a check is made to determine if the number of consonants in sequence in a text string is greater than a threshold value (where C=said number of consonants). In some embodiments, the threshold value can be three (3); however, it will be appreciated that other threshold values are also within the scope of the present invention. If the number of consonants in a sequence is greater than the threshold value, then flow proceeds to block 214, where the method indicates that the string is likely a computer generated string. If the number of consonants in a sequence is below the threshold value, then flow proceeds to block 216, where the method indicates that the text string is unlikely to have been generated by a computer.

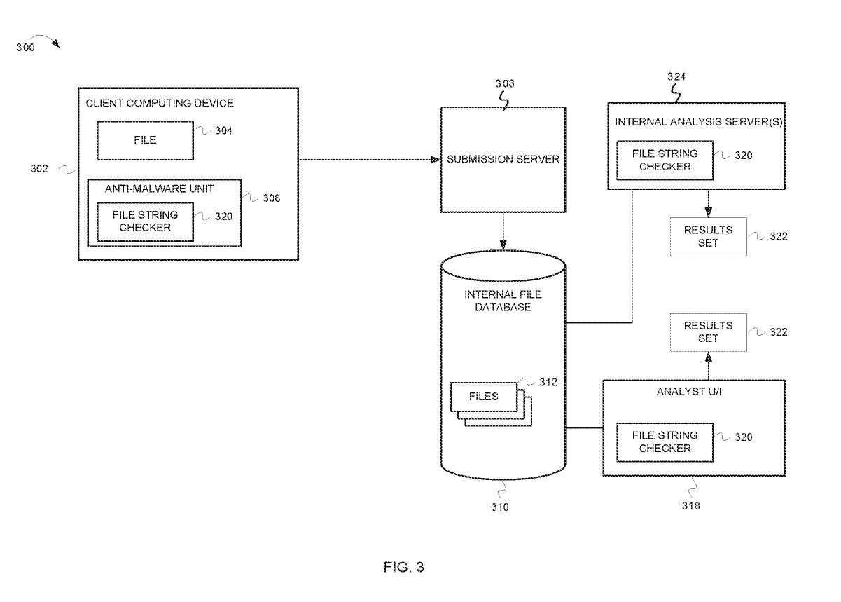

FIG. 3 is a block diagram illustrating an example system 300 utilizing file similarity fingerprints according to one embodiment of the present invention. In some embodiments, system 300 includes client computing device 302, submission server 308, internal file database 310, internal analysis server 324, and analyst user interface (U/I) 318.

Client computing device 302 can be a smartphone such as a smartphone running an Android operating system. Alternatively, computer 302 can be a desktop computer, laptop computer, tablet computer, personal digital assistant, media player, set top box, or any other device having one or more processors and memory for executing computer programs. The embodiments are not limited to any particular type of computing device. Client computing device 302 can include an anti-malware unit 306. Anti-malware unit 306 can include one or more of software, firmware or other programmable logic that can detect malicious files. Additionally, anti-malware unit 306 can submit a new file 304 for analysis. The new file may be a file that has not been seen before by the anti-malware unit 306, or may have only been seen on a low number of systems (e.g., the file may be a day one or zero-day malware source). Anti-malware unit 306 can include or otherwise be associated with a file string checker 320 that determines if the file includes any computer generated names for functions, methods or variables as described above in FIGS. 1 and 2. The results of the file string checker 320 can be used to determine if the file 304 contains malware, or is suspected of containing malware. In response to determining that the file contains malware, the anti-malware unit can alert the user, quarantine the file 304, and/or remove the malware from the file 304.

In response to determining that the file 304 is suspected of containing malware, client computing device 302 can submit file 304 to submission server 308. Submission server 308 can perform preprocessing on the new file 304 and add the new file to a collection of files 312.

Analyst U/I 318 can provide a user interface for an analyst to access tools that can be used to determine if a file contains malware. The analyst U/I 318 may include a file string checker 320 that determines if a file under analysis includes any computer generated names for functions, methods or variables as described above in FIGS. 1 and 2. The results of the file string checker 320 can be used to determine if the file under analysis contains malware, or is suspected of containing malware.

One or more internal analysis servers 324 can perform static or dynamic analysis of a file for internal database 310. In some aspects, an internal analysis application can perform a static analysis of a file. Internal analysis server 324 can include a file string checker 320 that determines if the file includes any computer generated names for functions, methods or variables as described above in FIGS. 1 and 2. The results of the file string checker 320 can be used to determine if any of files 212 contains malware, or is suspected of containing malware.

The analyst U/I 318 and/or the internal analysis server 324 can produce a results set 322 that includes files determined to be clean or files determined to contain malware using the file string checker 320.

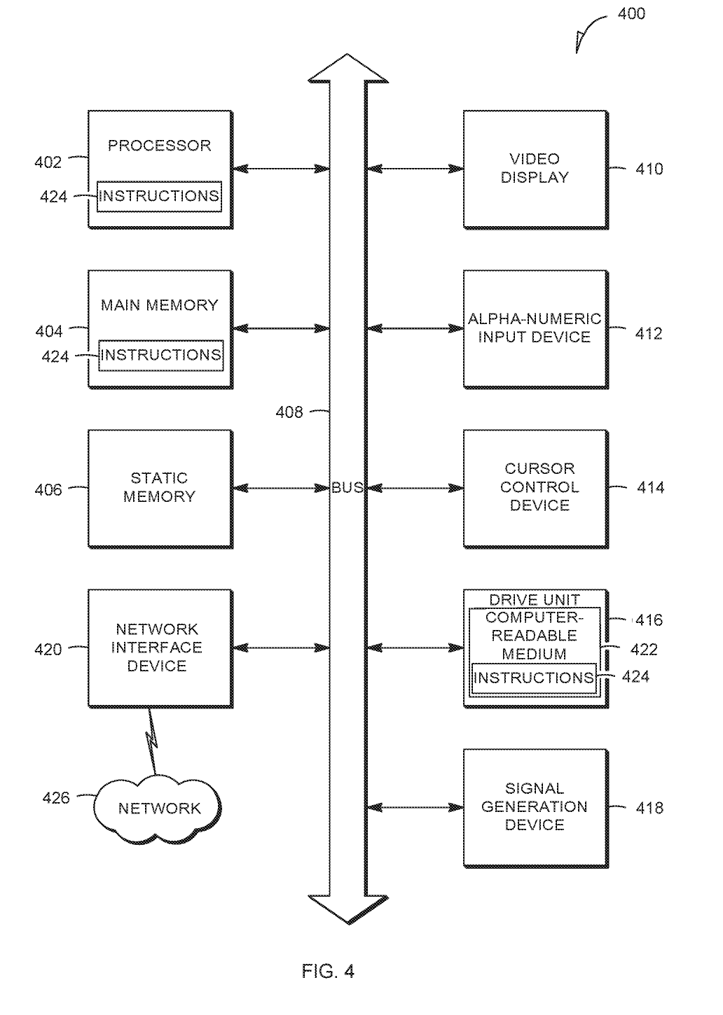

FIG. 4 is a block diagram of an example embodiment of a computer system 400 upon which embodiments of the inventive subject matter can execute. The description of FIG. 4 is intended to provide a brief, general description of suitable computer hardware and a suitable computing environment in conjunction with which the invention may be implemented. In some embodiments, the inventive subject matter is described in the general context of computer-executable instructions, such as program modules, being executed by a computer. Generally, program modules include routines, programs, objects, components, data structures, etc., that perform particular tasks or implement particular abstract data types.

As indicated above, the system as disclosed herein can be spread across many physical hosts. Therefore, many systems and sub-systems of FIG. 4 can be involved in implementing the inventive subject matter disclosed herein.

Moreover, those skilled in the art will appreciate that the invention may be practiced with other computer system configurations, including hand-held devices, multiprocessor systems, microprocessor-based or programmable consumer electronics, smartphones, network PCs, minicomputers, mainframe computers, and the like. Embodiments of the invention may also be practiced in distributed computer environments where tasks are performed by I/O remote processing devices that are linked through a communications network. In a distributed computing environment, program modules may be located in both local and remote memory storage devices.

With reference to FIG. 4, an example embodiment extends to a machine in the example form of a computer system 400 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 400 may include a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). In example embodiments, the computer system 400 also includes one or more of an alpha-numeric input device 412 (e.g., a keyboard), a user interface (UI) navigation device or cursor control device 414 (e.g., a mouse), a disk drive unit 416, a signal generation device 418 (e.g., a speaker), and a network interface device 420.

The disk drive unit 416 includes a machine-readable medium 422 on which is stored one or more sets of instructions 424 and data structures (e.g., software instructions) embodying or used by any one or more of the methodologies or functions described herein. The instructions 424 may also reside, completely or at least partially, within the main memory 404 or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 424 may further be transmitted or received over a communications network 426 using a signal transmission medium via the network interface device 420 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “machine-readable signal medium” shall be taken to include any transitory intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof.

The Abstract is provided to comply with 37 C.F.R. § 1.72(b) to allow the reader to quickly ascertain the nature and gist of the technical disclosure. The Abstract is submitted with the understanding that it will not be used to limit the scope of the claims.

What is claimed is:

1. A method for determining existence of malware in a file, the method comprising:
receiving an executable file;
determining a set of text strings in the executable file, the text strings including at least one member of the group consisting of a function name, a variable name, or a method name; and
determining that the executable file potentially contains malware in response to determining that at least one text string of the set of text strings is a computer generated text string.

2. The method of claim 1, wherein determining that at least one text string of the set of text strings is a computer generated text string comprises determining that a ratio of consonants to vowels in the at least one text string is greater than a predetermined or configurable threshold value.

3. The method of claim 2, wherein determining that the ratio of consonants to vowels in the at least one text string is greater than a predetermined or configurable threshold value comprises:
determining a number of consonants in the at least one text string;
determining a number of vowels in the at least one text string; and
dividing the number of consonants by the number of vowels to determine the ratio of consonants to vowels.

4. The method of claim 2, wherein the predetermined or configurable threshold value for the ratio of consonants to vowels is 3.0.

5. The method of claim 1, wherein determining that at least one text string of the set of text strings is a computer generated text string comprises determining that a number of consonants in a sequence uninterrupted by a vowel in the at least one text string is greater than a predetermined or configurable threshold value.

6. The method of claim 5, wherein the predetermined or configurable threshold value for the number of consonants in a sequence uninterrupted by a vowel is 3.0.

7. The method of claim 1, wherein determining that at least one text string of the set of text strings is a computer generated text string comprises performing an iteration over the set of text strings, the iteration including:
determining whether a ratio of consonants to vowels for the at least one text string is greater than a predetermined or configurable first threshold value;
determining whether a number of consonants in a sequence uninterrupted by a vowel in the at least one text string is greater than a predetermined or configurable second threshold value; and
indicating that the at least one text string is likely a computer generated string if either the first threshold value or the second threshold value is exceeded.

8. A non-transitory machine-readable medium having instructions stored thereon, the instructions comprising computer executable instructions that when executed, cause one or more processors to:
receive an executable file;
determine a set of text strings in the executable file, the text strings including at least one member of the group consisting of a function name, a variable name, or a method name; and
determine that the executable file potentially contains malware in response to determining that at least one text string of the set of text strings is a computer generated text string.

9. The non-transitory machine-readable medium of claim 8, wherein determining that at least one text string of the set of text strings is a computer generated text string comprises determining that a ratio of consonants to vowels in the at least one text string is greater than a predetermined or configurable threshold value.

10. The non-transitory machine-readable medium of claim 8, wherein the computer executable instructions further comprise computer executable instructions to:
determine a number of consonants in the at least one text string;
determine a number of vowels in the at least one text string;
divide the number of consonants by the number of vowels to determine the ratio of consonants to vowels; and
determine that the ratio of consonants to vowels is greater than a predetermined or configurable threshold value.

11. The non-transitory machine-readable medium of claim 10, wherein the predetermined or configurable threshold value for the ratio of consonants to vowels is 3.0.

12. The non-transitory machine-readable medium of claim 8, wherein the computer executable instructions further comprise computer executable instructions to:
determine that at least one text string of the set of text strings is a computer generated text string comprises determining that a number of consonants in a sequence uninterrupted by a vowel in the at least one text string is greater than a predetermined or configurable threshold value.

13. The non-transitory machine-readable medium of claim 12, wherein the predetermined or configurable threshold value for the number of consonants in a sequence uninterrupted by a vowel is 3.0.

14. The non-transitory machine-readable medium of claim 8, wherein the computer executable instructions further comprise computer executable instructions to:
perform an iteration over the set of text strings, the iteration adapted to:
determine whether a ratio of consonants to vowels for at least one text string is greater than a predetermined or configurable first threshold value;
determine whether a number of consonants in a sequence uninterrupted by a vowel in at least one text string is greater than a predetermined or configurable second threshold value; and
indicate that at least one text string is likely a computer generated string if either the first threshold value is exceeded or the second threshold value is exceeded.

15. A system for determining existence of malware in a file, the system comprising:
one or more processors; and
a non-transitory machine-readable medium having computer executable instructions stored thereon, that when executed, cause the one or more processors to:
receive an executable file;
determine a set of text strings in the executable file, the text strings including at least one member of the group consisting of a function name, a variable name, or a method name; and
determine that the executable file potentially contains malware in response to determining that at least one text string of the set of text strings is a computer generated text string.

16. The system of claim 15, wherein determining that at least one text string of the set of text strings is a computer generated text string comprises determining that a ratio of consonants to vowels in the at least one text string is greater than a predetermined or configurable threshold value.

17. The system of claim 15, wherein the computer executable instructions further comprise computer executable instructions to:
determine a number of consonants in at least one text string of the set of text strings;
determine a number of vowels in the at least one text string;
divide the number of consonants by the number of vowels to determine the ratio of consonants to vowels; and
determine that the ratio of consonants to vowels is greater than a predetermined or configurable threshold value.

18. The system of claim 17, wherein the predetermined or configurable threshold value for the ratio of consonants to vowels is 3.0.

19. The system of claim 15, wherein the computer executable instructions further comprise computer executable instructions to:
determine that at least one text string of the set of text strings is a computer generated text string comprises determining that a number of consonants in a sequence uninterrupted by a vowel in the at least one text string is greater than a predetermined or configurable threshold value.

20. The system of claim 19, wherein the predetermined or configurable threshold value for the number of consonants in a sequence uninterrupted by a vowel is 3.0.

21. The system of claim 15, wherein the computer executable instructions further comprise computer executable instructions to:
perform an iteration over the set of text strings, the iteration adapted to:
determine whether a ratio of consonants to vowels for at least one text string is greater than a predetermined or configurable first threshold value;
determine whether a number of consonants in a sequence uninterrupted by a vowel in at least one text string is greater than a predetermined or configurable second threshold value; and
indicate that at least one text string is likely a computer generated string if either the first threshold value is exceeded or the second threshold value is exceeded.
